(19) United States
(12) Patent Application Publication
(10) Pub. No.: US 2016/0189184 A1
(43) Pub. Date: Jun. 30, 2016

(54) METHOD AND SYSTEM FOR IDENTIFYING GEOGRAPHIC MARKETS FOR MERCHANT EXPANSION

(71) Applicant: MasterCard International Incorporated, Purchase, NY (US)

(72) Inventors: Edward M. Lee, Scarsdale, NY (US); Lindsay St. Lawrence, West Harrison, NY (US)

(21) Appl. No.: 14/585,244

(22) Filed: Dec. 30, 2014

(51) Int. Cl. G06Q 30/02

(52) U.S. Cl. CPC G06Q 30/0205; G06Q 30/0201

(57) ABSTRACT

A method and a system are provided for identifying geographic markets for merchant expansion. In particular, a method and a system are provided for identifying geographic markets for merchant expansion based on the geolocations of the purchasing and payment activities of payment card holders and/or geolocations of residence of the payment card holders. The method and system identify a merchant's best customers, build a look-alike model to the merchant's best customers (best prospect customers), and analyze the best prospect customers' spend at a zip code level to identify geolocations for merchant expansion. Predictive merchant expansion models are generated based on the geolocations of the purchasing and payment activities of the payment card holders and/or geolocations of residence of the payment card holders.

### BACKGROUND OF THE DISCLOSURE

1. Field of the Disclosure

The present disclosure relates to a method and a system for identifying geographic markets for merchant expansion. In particular, the present disclosure relates to a method and a system for identifying geographic markets for merchant expansion based on the geolocations of the purchasing and payment activities of payment card holders and/or geolocations of residence of the payment card holders.

2. Description of the Related Art

Merchants need a robust tool to determine where they can expand their business. Currently merchants are using modeling based on their own business performance and external data sources like demographics and population size, available retail space, directional trade areas, etc. Most, if any, modeling is primarily done using their existing data, but limited to the transactional-based lookalikes spending with their competitive set.

For many merchants, there is a lack of specific metrics and understanding of where they can expand their business. As a result, the ability to better grow their business and attract shoppers for specific stores at specific locations can be a problem. Moreover, there can be missed opportunities to attract additional shopper spend by not understanding the overall shopper profile in terms of merchant location.

Merchants have an interest in knowing, for their particular geographical area of business, where shoppers are coming from and what they are buying. Information useful to such merchants can include, for example, where shoppers are coming from; whether shoppers are spending more or less in a particular area/place/industry in comparison to a competing area/place/industry and if so, how much; what shoppers are spending on including which industries and merchants; when shoppers are buying and what times shoppers are buying; whether there is seasonality involved with the shopper trade in a particular geographical area; and the like.

With such information, a merchant, for example, can better decide where to expand their business without incurring reduced shopper flow and reduced purchase transactions at the new location. For appealing to potential shoppers from various locations, a merchant can enhance the shopper experience with a store conveniently located to the potential shoppers. Also, such information would allow merchants to plan according to shopper arrival seasonality at a particular destination site with a store located at the destination site. Such information is not currently being used by merchants for business expansion decision making.

Business expansion can be very expensive for a merchant. Business expansion difficulties in effectively identifying where to expand a business, is an industry wide challenge, regardless of the goods or services offered. In an attempt to overcome these difficulties, entities often engage in various expansion techniques, such as modeling described above, hoping to reach interested shoppers at the new location. However, such broad expansion techniques often result in locations that fail to reach the intended shopper audience.

Information on potential shoppers can be very important to sellers of goods and services. Merchants benefit from having detailed information about buying interests or capacities of potential purchasers of goods or services, where they shop, where they live, and the like. If a merchant, for instance, can identify potential shoppers who fit a profile of probable purchasers of the merchant's goods or services, and also identify where they shop and where they live, the merchant can use this information to better assess where to expand a business. In other words, if the merchant has both information about potential shoppers and pertinent location information, it can use this information to select a location for an expansion business having conveniently located purchasers/customers. Useful financial and demographic information for such a strategy includes a potential shopper's financial status, age, residence, and interests in various goods and services.

If a merchant has access to such financial and demographic information about potential shoppers, the merchant can selectively choose a site for business expansion that is more convenient and attractive for shoppers. With such information, the merchant can concentrate on specific potential shoppers who may be likely to visit a particular merchant location site or to buy a specific good or service.

Therefore, a need exists for a system that can provide more effective metrics and an understanding of where merchants can profitably expand their business. A more holistic view of a shopper's personal circumstances, including spending habits, is needed for effective decision making for business expansion. Further, a need exists for a system that can analyze a shopper's personal circumstances and identify shopping activities and circumstances that can be used by a merchant to identify geographic markets for merchant expansion.

### SUMMARY OF THE DISCLOSURE

The present disclosure provides a method and a system for identifying geographic markets for merchant expansion. In particular, the present disclosure provides a method and a system for identifying geographic markets for merchant expansion based on the geolocations of the purchasing and payment activities of payment card holders and/or geolocations of residence of the payment card holders.

The present disclosure further provides a method that includes analyzing purchasing and payment activities of a first grouping of payment card holders at a first merchant, and analyzing purchasing and payment activities of a second grouping of payment card holders at one or more second merchants. The one or more second merchants are selected from one or more first merchant competitors. The purchasing and payment activities of the second grouping of payment card holders are representative of the purchasing and payment activities of the first grouping of payment card holders. The method further includes identifying geolocations of the purchasing and payment activities of the second grouping of payment card holders at the one or more second merchants and/or geolocations of residence of the second grouping of payment card holders; and identifying geographic markets for first merchant expansion based on the geolocations of the purchasing and payment activities of the second grouping of payment card holders at the one or more second merchants and/or geolocations of residence of the second grouping of payment card holders.

The present disclosure also provides a method that includes retrieving from one or more databases a first set of information having purchasing and payment activity information attributable to a plurality of payment card holders, and retrieving from one or more databases a second set of information having merchant information associated with the purchasing and payment activity. The method also includes analyzing the first set of information and the second set of information to identify purchasing and payment activities of a first grouping of payment card holders at a first merchant; analyzing the first set of information and the second set of information to generate one or more groupings of first merchant competitors; and analyzing the first set of information and the second set of information to identify purchasing and payment activities of a second grouping of payment card holders at one or more second merchants selected from the one or more groupings of first merchant competitors. The purchasing and payment activities of the second grouping of payment card holders are representative of the purchasing and payment activities of the first grouping of payment card holders. The method further includes assessing the purchasing and payment activities of the second grouping of payment card holders to identify geolocations of the purchasing and payment activities of the second grouping of payment card holders at the one or more second merchants and/or geolocations of residence of the second grouping of payment card holders; and identifying geographic markets for first merchant expansion based on the geolocations of the purchasing and payment activities of the second grouping of payment card holders at the one or more second merchants and/or geolocations of residence of the second grouping of payment card holders.

The present disclosure further provides a system that includes one or more databases configured to store information including purchasing and payment activity information attributable to a plurality of payment card holders, and one or more databases configured to store information including merchant information associated with the purchasing and payment activity. The system includes a processor configured to: analyze purchasing and payment activities of a first grouping of payment card holders at a first merchant, and analyze purchasing and payment activities of a second grouping of payment card holders at one or more second merchants. The one or more second merchants are selected from one or more first merchant competitors. The purchasing and payment activities of the second grouping of payment card holders are representative of the purchasing and payment activities of the first grouping of payment card holders. The processor is also configured to identify geolocations of the purchasing and payment activities of the second grouping of payment card holders at the one or more second merchants and/or geolocations of residence of the second grouping of payment card holders; and identify geographic markets for first merchant expansion based on the geolocations of the purchasing and payment activities of the second grouping of payment card holders at the one or more second merchants and/or geolocations of residence of the second grouping of payment card holders.

The present disclosure yet further provides a system that includes one or more databases configured to store a first set of information including purchasing and payment activity information attributable to a plurality of payment card holders, and one or more databases configured to store a second set of information including merchant information associated with the purchasing and payment activity. The system also includes a processor configured to: analyze the first set of information and the second set of information to identify purchasing and payment activities of a first grouping of payment card holders at a first merchant; analyze the first set of information and the second set of information to generate one or more groupings of first merchant competitors; and analyze the first set of information and the second set of information to identify purchasing and payment activities of a second grouping of payment card holders at one or more second merchants selected from the one or more groupings of first merchant competitors. The purchasing and payment activities of the second grouping of payment card holders are representative of the purchasing and payment activities of the first grouping of payment card holders. The processor is also configured to: assess the purchasing and payment activities of the second grouping of payment card holders to identify geolocations of the purchasing and payment activities of the second grouping of payment card holders at the one or more second merchants and/or geolocations of residence of the second grouping of payment card holders; and identify geographic markets for first merchant expansion based on the geolocations of the purchasing and payment activities of the second grouping of payment card holders at the one or more second merchants and/or geolocations of residence of the second grouping of payment card holders.

The present disclosure also provides a method for generating one or more predictive merchant expansion models. The method includes analyzing purchasing and payment activities of a first grouping of payment card holders at a first merchant, and analyzing purchasing and payment activities of a second grouping of payment card holders at one or more second merchants. The one or more second merchants are selected from one or more first merchant competitors. The purchasing and payment activities of the second grouping of payment card holders are representative of the purchasing and payment activities of the first grouping of payment card holders. The method further includes identifying geolocations of the purchasing and payment activities of the second grouping of payment card holders at the one or more second merchants and/or geolocations of residence of the second grouping of payment card holders; identifying geographic markets for first merchant expansion based on the geolocations of the purchasing and payment activities of the second grouping of payment card holders at the one or more second merchants and/or geolocations of residence of the second grouping of payment card holders; and generating one or more predictive merchant expansion models based on the geolocations of the purchasing and payment activities of the second grouping of payment card holders at the one or more second merchants and/or geolocations of residence of the second grouping of payment card holders.

The present disclosure further provides a method for generating one or more predictive merchant expansion models. The method includes retrieving from one or more databases a first set of information including purchasing and payment activity information attributable to a plurality of payment card holders, and retrieving from one or more databases a second set of information including merchant information associated with the purchasing and payment activity. The method also includes analyzing the first set of information and the second set of information to identify purchasing and payment activities of a first grouping of payment card holders at a first merchant; analyzing the first set of information and the second set of information to generate one or more groupings of first merchant competitors; and analyzing the first set of information and the second set of information to identify purchasing and payment activities of a second grouping of payment card holders at one or more second merchants selected from the one or more groupings of first merchant competitors. The purchasing and payment activities of the second grouping of payment card holders are representative of the purchasing and payment activities of the first grouping of payment card holders. The method further includes assessing the purchasing and payment activities of the second grouping of payment card holders to identify geolocations of the purchasing and payment activities of the second grouping of payment card holders at the one or more second merchants and/or geolocations of residence of the second grouping of payment card holders; identifying geographic markets for first merchant expansion based on the geolocations of the purchasing and payment activities of the second grouping of payment card holders at the one or more second merchants and/or geolocations of residence of the second grouping of payment card holders; and generating one or more predictive merchant expansion models based on the geolocations of the purchasing and payment activities of the second grouping of payment card holders at the one or more second merchants and/or geolocations of residence of the second grouping of payment card holders.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 shows illustrative information types used in the systems and the methods of the present disclosure.

FIG. 4 shows illustrative merchants in selected industry categories in accordance with exemplary embodiments of the present disclosure.

FIG. 5 illustrates an exemplary dataset for the storing, reviewing, and/or analyzing of information used in the systems and the methods of the present disclosure.

FIG. 6 is a block diagram illustrating a method for conveying suggestions or recommendations to a merchant for market expansion in accordance with exemplary embodiments of the present disclosure.

FIG. 7 illustrates an exemplary solution methodology for identifying geographic markets for merchant expansion in accordance with exemplary embodiments of this disclosure.

FIG. 8 illustrates an exemplary total market opportunity scope for merchant expansion in accordance with exemplary embodiments of this disclosure.

FIG. 9 illustrates an exemplary data set for identifying geographic markets for merchant expansion in accordance with exemplary embodiments of this disclosure.

FIG. 10 is a block diagram illustrating a method for generating one or more predictive merchant expansion models in accordance with exemplary embodiments of this disclosure.

A component or a feature that is common to more than one drawing is indicated with the same reference number in each drawing.

### DESCRIPTION OF THE PREFERRED EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, and the one or more databases configured to store the second set of information or from which the second set of information is retrieved, and the one or more databases configured to store the third set of information or from which the third set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information including purchasing and payment activity information attributable to a plurality of payment card holders, and retrieve from one or more databases a second set of information including merchant information associated with the purchasing and payment activity. The method also analyzes the first set of information and the second set of information to identify purchasing and payment activities of a first grouping of payment card holders at a first merchant; analyzes the first set of information and the second set of information to generate one or more groupings of first merchant competitors; and analyzes the first set of information and the second set of information to identify purchasing and payment activities of a second grouping of payment card holders at one or more second merchants selected from the one or more groupings of first merchant competitors, in which the purchasing and payment activities of the second grouping of payment card holders are representative of the purchasing and payment activities of the first grouping of payment card holders. The method further assesses the purchasing and payment activities of the second grouping of payment card holders to identify geolocations of the purchasing and payment activities of the second grouping of payment card holders at the one or more second merchants and/or geolocations of residence of the second grouping of payment card holders; and identifies geographic markets for first merchant expansion based on the geolocations of the purchasing and payment activities of the second grouping of payment card holders at the one or more second merchants and/or geolocations of residence of the second grouping of payment card holders.

Among many potential uses, the systems and methods described herein can be used to: (1) identify for merchants geographic markets for merchant expansion; (2) identify for merchants purchasing and payment activities of domestic payment card holders and foreign payment card holders; this identification can be geospatially from regions down to each individual store location; (3) identify for merchants where domestic payment card holders and foreign payment card holders are coming from; this identification can be geospatially from regions down to each individual store location; (4) identify for merchants competitors in the industry (the competition); (5) compare and contrast domestic payment card holder spend and foreign payment card holder spend with competitors in the industry (or the competition); and (6) determine the seasonality of payment card holder purchasing behavior at the merchant location. Other uses are possible.

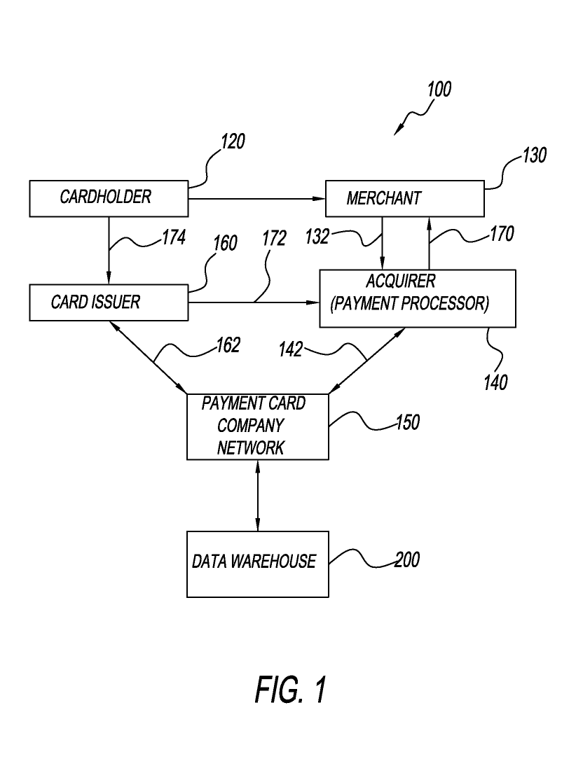

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) analyzing the first set of information and the second set of information to identify purchasing and payment activities of a first grouping of payment card holders at a first merchant; (ii) analyzing the first set of information and the second set of information to generate one or more groupings of first merchant competitors; (iii) analyzing the first set of information and the second set of information to identify purchasing and payment activities of a second grouping of payment card holders at one or more second merchants selected from the one or more groupings of first merchant competitors, in which the purchasing and payment activities of the second grouping of payment card holders are representative of the purchasing and payment activities of the first grouping of payment card holders; (iv) assessing the purchasing and payment activities of the second grouping of payment card holders to identify geolocations of the purchasing and payment activities of the second grouping of payment card holders at the one or more second merchants and/or geolocations of residence of the second grouping of payment card holders; and (v) identifying geographic markets for first merchant expansion based on the geolocations of the purchasing and payment activities of the second grouping of payment card holders at the one or more second merchants and/or geolocations of residence of the second grouping of payment card holders.

In yet another embodiment, data warehouse 200 stores, reviews, and/or analyzes information used in generating one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders.

The one or more indices are a measure of the degree to which total domestic payment card holder purchasing and payment activity at the one or more second merchants, and total foreign payment card holder purchasing and payment activity at the one or more second merchants, are correlated for a defined time period.

In yet another embodiment, data warehouse 200 stores, reviews, and/or analyzes information used in (i) analyzing the first set of information and the second set of information to identify purchasing and payment activities of a first grouping of payment card holders at a first merchant; (ii) analyzing the first set of information and the second set of information to generate one or more groupings of first merchant competitors; (iii) analyzing the first set of information and the second set of information to identify purchasing and payment activities of a second grouping of payment card holders at one or more second merchants selected from the one or more groupings of first merchant competitors, in which the purchasing and payment activities of the second grouping of payment card holders are representative of the purchasing and payment activities of the first grouping of payment card holders; (iv) assessing the purchasing and payment activities of the second grouping of payment card holders to identify geolocations of the purchasing and payment activities of the second grouping of payment card holders at the one or more second merchants and/or geolocations of residence of the second grouping of payment card holders; (v) identifying geographic markets for first merchant expansion based on the geolocations of the purchasing and payment activities of the second grouping of payment card holders at the one or more second merchants and/or geolocations of residence of the second grouping of payment card holders; and (vi) generating one or more predictive merchant expansion models based on the geolocations of the purchasing and payment activities of the second grouping of payment card holders at the one or more second merchants and/or geolocations of residence of the second grouping of payment card holders.

In still another embodiment, data warehouse 200 stores, reviews, and/or analyzes information used in creating one or more datasets to store information relating to (i) purchasing and payment activities of the plurality of payment card holders; (ii) one or more categories of merchants based on merchant line of business (competitors), the one or more categories of merchants associated with the purchasing and payment activities of the plurality of payment card holders; (iii) purchasing and payment behavior of the plurality of payment card holders at one or more merchants based on the purchasing and payment activities of the plurality of payment card holders, and the one or more categories of merchants; and (iv) identifying geographic markets for merchant expansion based on the geolocations of the purchasing and payment activities of the payment card holders and/or geolocations of residence of the payment card holders.

In still another embodiment, data warehouse 200 stores, reviews, and/or analyzes information used in creating one or more datasets to store information relating to one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders.

In still yet another embodiment, data warehouse 200 stores, reviews, and/or analyzes information used in creating one or more datasets to store information relating to (i) purchasing and payment activities of the plurality of payment card holders; (ii) one or more categories of merchants based on merchant line of business, the one or more categories of merchants associated with the purchasing and payment activities of the plurality of payment card holders; (iii) one or more predictive merchant expansion models based on the purchasing and payment activities of plurality of payment card holders, the one or more categories of merchants, and the geolocations of the purchasing and payment activities of the second grouping of payment card holders at the one or more second merchants and/or geolocations of residence of the second grouping of payment card holders.

In another embodiment, data warehouse 200 stores, reviews, and/or analyzes information used in developing logic for (i) analyzing the first set of information and the second set of information to identify purchasing and payment activities of a first grouping of payment card holders at a first merchant; (ii) analyzing the first set of information and the second set of information to generate one or more groupings of first merchant competitors; (iii) analyzing the first set of information and the second set of information to identify purchasing and payment activities of a second grouping of payment card holders at one or more second merchants selected from the one or more groupings of first merchant competitors; wherein the purchasing and payment activities of the second grouping of payment card holders are representative of the purchasing and payment activities of the first grouping of payment card holders; (iv) assessing the purchasing and payment activities of the second grouping of payment card holders to identify geolocations of the purchasing and payment activities of the second grouping of payment card holders at the one or more second merchants and/or geolocations of residence of the second grouping of payment card holders; and (v) identifying geographic markets for first merchant expansion based on the geolocations of the purchasing and payment activities of the second grouping of payment card holders at the one or more second merchants and/or geolocations of residence of the second grouping of payment card holders.

In still another embodiment, data warehouse 200 stores, reviews, and/or analyzes information used in developing logic for generating one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders.

In yet another embodiment, data warehouse 200 stores, reviews, and/or analyzes information used in developing logic for (i) analyzing the first set of information and the second set of information to identify purchasing and payment activities of a first grouping of payment card holders at a first merchant; (ii) analyzing the first set of information and the second set of information to generate one or more groupings of first merchant competitors; (iii) analyzing the first set of information and the second set of information to identify purchasing and payment activities of a second grouping of payment card holders at one or more second merchants selected from the one or more groupings of first merchant competitors; wherein the purchasing and payment activities of the second grouping of payment card holders are representative of the purchasing and payment activities of the first grouping of payment card holders; (iv) assessing the purchasing and payment activities of the second grouping of payment card holders to identify geolocations of the purchasing and payment activities of the second grouping of payment card holders at the one or more second merchants and/or geolocations of residence of the second grouping of payment card holders; (v) identifying geographic markets for first merchant expansion based on the geolocations of the purchasing and payment activities of the second grouping of payment card holders at the one or more second merchants and/or geolocations of residence of the second grouping of payment card holders; and (vi) generating one or more predictive merchant expansion models based on the geolocations of the purchasing and payment activities of the second grouping of payment card holders at the one or more second merchants and/or geolocations of residence of the second grouping of payment card holders.

In still another embodiment, data warehouse 200 stores, reviews, and/or analyzes information used in quantifying the strength of the (i) purchasing and payment behavior of the plurality of payment card holders at one or more merchants based on the purchasing and payment activities of the plurality of payment card holders and the one or more categories of merchants; (ii) one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders; (iii) one or more predictive merchant expansion models based on the geolocations of the purchasing and payment activities of the second grouping of payment card holders at the one or more second merchants and/or geolocations of residence of the second grouping of payment card holders; and (iv) one or more predictive merchant expansion models based on the one or more indices.

In another embodiment, data warehouse 200 stores, reviews, and/or analyzes information, with respect to the (i) one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders, and (ii) one or more predictive merchant expansion models based on the one or more indices, used in assigning attributes to the one or more payment card holder purchase behaviors and the one or more categories of merchants, in which the attributes are selected from one or more of confidence, time, and frequency.

In still another embodiment, data warehouse 200 stores, reviews, and/or analyzes information used in targeting information including at least one or more suggestions or recommendations for an entity (e.g., merchant) for merchant expansion, based on the one or more indices or the one or more predictive merchant expansion models.

In another embodiment, data warehouse 200 aggregates the information by payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

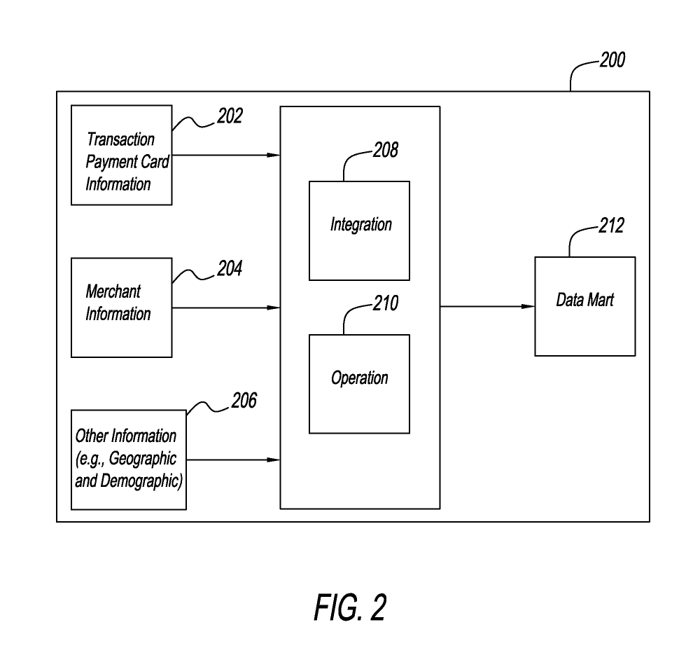

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202 and 204).

The transaction payment card information 202 can include, for example, payment card transaction information, payment card holder information, and purchasing and payment activities attributable to payment card holders, that can be aggregated by payment card holder, country of origin of payment card holder, category and/or location in the data warehouse 200. The transaction payment card information 202 can also include, for example, a transaction identifier, geolocation of payment card transaction, geolocation date on which payment card transaction occurred, geolocation time on which payment card transaction occurred, and the like.

The merchant information 204 can include, for example, categories of merchants, and the like. The merchant information 204 can also include, for example, a merchant identifier, geolocation of merchant, and the like.

The other information 206 includes, for example, geographic data, firmographic data, and demographic data. The other information 206 can include other suitable information that can be useful in assessing the purchasing and payment activities of the second grouping of payment card holders to identify geolocations of the purchasing and payment activities of the second grouping of payment card holders at the one or more second merchants and/or geolocations of residence of the second grouping of payment card holders, generating one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders, and generating one or more predictive merchant expansion models based on the geolocations of the purchasing and payment activities of the second grouping of payment card holders at the one or more second merchants and/or geolocations of residence of the second grouping of payment card holders.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information and/or generation of indices and/or the generation of predictive merchant expansion models using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

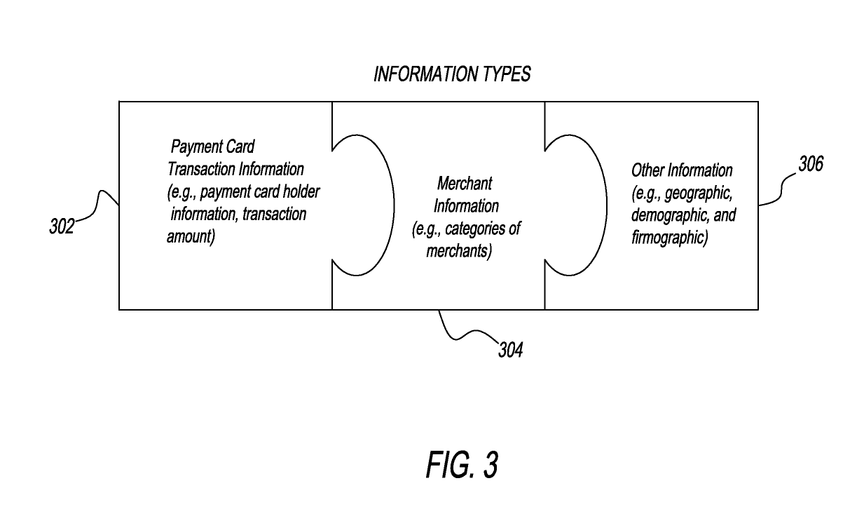

In accordance with the method of this disclosure, information that is stored in one or more databases can be retrieved (e.g., by a processor). FIG. 3 shows illustrative information types used in the systems and methods of this disclosure.

The information can include, for example, a first set of information 302 that can be retrieved from one or more databases owned or controlled by an entity, for example, a payment card company (part of the payment card company network 150 in FIG. 1). The transaction payment card information 302 can include, for example, payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, country of origin of payment card holder, category and/or location, transaction date and time, and transaction amount. The transaction payment card information 302 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 304 can include, for example, categories of merchants, merchant name, merchant geography, merchant line of business, and the like. The merchant information 304 can also include, for example, a merchant identifier, geolocation of merchant, and the like.

One or more databases are used for storing information of one or more merchants, and merchants belonging to a particular category, e.g., industry category. Illustrative merchant categories are described herein. The merchant categorization is useful for generating one or more indices and one or more predictive merchant expansion models based on the one or more indices.

In an embodiment, a merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of generating one or more indices and one or more predictive merchant expansion models based on the one or more indices, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photo finishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

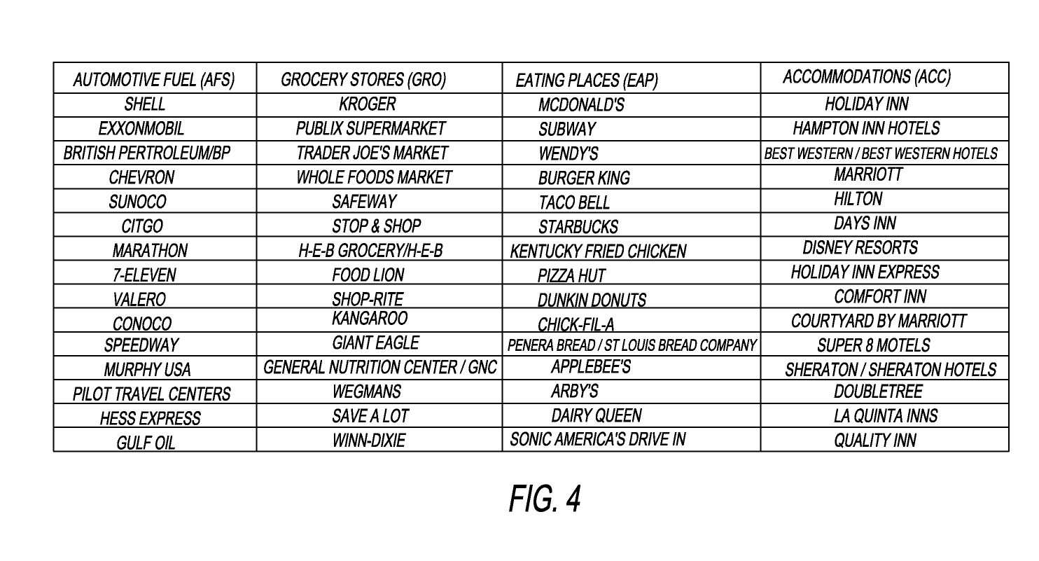

Illustrative merchants and industry categorization are shown in FIG. 4. The illustrative industry categories include AFS Automotive Fuel, GRO Grocery Stores, EAP Eating Places, and ACC Accommodations. Illustrative merchants associated with the industry categories are listed in FIG. 4. In accordance with this disclosure, merchant categorization is important for indexing purchasing and payment activities of payment card holders. Proper merchant categorization is important to obtain indexing results that are truly reflective of the particular merchant and industry, in particular, to determine how purchasing and payment activities of payment card holders is trending for one merchant in comparison to another merchant in the same industry category.

Also, the information can optionally include, for example, a third set of information including other information 306. Illustrative third set information can include, for example, geographic data, firmographic data, demographic data, and the like. In particular, the third set of information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The third set of information affords leveraged data sources that can supplement information in the first set of information and the second set of information.

The other information 306 can further include firmographics data, for example, line of operations for a business, information related to employees, revenues and industries, and the like. In particular, the firmographics data relates to information on merchants that is typically used in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing in a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production can reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Merchant payment trend information can include, for example, information that spots trends in a merchant's business by analyzing how it pays its bills.

Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Merchant public filing information can include, for example, bankruptcy filings, suits, liens, and judgment information obtained from Federal and State court houses for a company.

Demographic information can also be used to supplement or leverage the first set of information and the second set of information. Illustrative demographic information includes, for example, age, income, presence of children, education, and the like.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific index is retrieved from each of the databases.

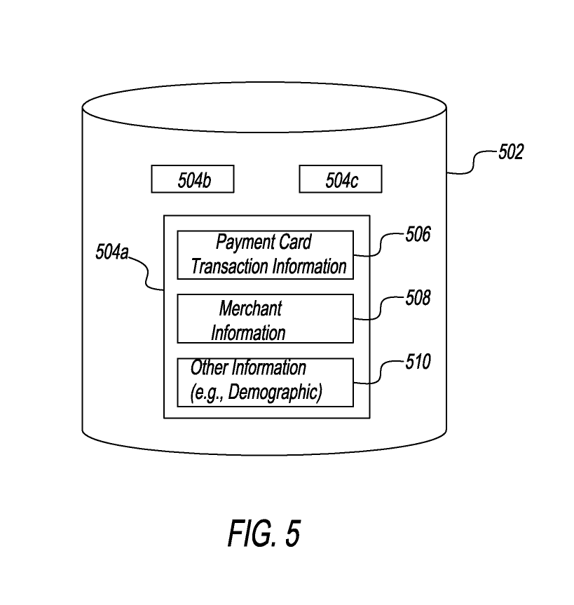

Referring to FIG. 5, an exemplary dataset 502 stores, reviews, and/or analyzes of information used in the systems and methods of this disclosure. The dataset 502 can include a plurality of entries (e.g., entries 504a, 504b, and 504c).

The payment card transaction information 506 includes payment card transactions and actual spending by payment card holders. More specifically, payment card transaction information 506 can include, for example, payment card transaction information, transaction date and time, transaction amount, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, country of origin of payment card holder, category and/or location, transaction date and time, and transaction amount. The transaction payment card information 506 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The merchant information 508 can include, for example, categories of merchants, merchant name, merchant geography, merchant line of business, and the like. The merchant information 508 can also include, for example, a merchant identifier, geolocation of merchant, and the like.

The other information 510 includes, for example, geographic data, firmographic data, demographic data, and other suitable information that can be useful in conducting the systems and methods of this disclosure.

Algorithms can be employed to determine formulaic descriptions of the integration of the payment card transaction information 506, merchant information 508 and optionally the other information 510 using any of a variety of known mathematical techniques. These formulas, in turn, can be used to derive or generate one or more analyses and updates using any of a variety of available trend analysis algorithms. For example, these formulas can be used to assess the purchasing and payment activities of the second grouping of payment card holders to identify geolocations of the purchasing and payment activities of the second grouping of payment card holders at the one or more second merchants and/or geolocations of residence of the second grouping of payment card holders, generate one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders, and generate one or more predictive merchant expansion models based on the geolocations of the purchasing and payment activities of the second grouping of payment card holders at the one or more second merchants and/or geolocations of residence of the second grouping of payment card holders.

In an embodiment, logic is developed for assessing the purchasing and payment activities of the second grouping of payment card holders to identify geolocations of the purchasing and payment activities of the second grouping of payment card holders at the one or more second merchants and/or geolocations of residence of the second grouping of payment card holders, generating one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders, and generating one or more predictive merchant expansion models based on the geolocations of the purchasing and payment activities of the second grouping of payment card holders at the one or more second merchants and/or geolocations of residence of the second grouping of payment card holders. The logic is applied to a universe of payment card holders to identify purchasing and payment activities of the universe of payment card holders at one or more merchants.

In accordance with the method of this disclosure, information that is stored in one or more databases can be retrieved (e.g., by a processor). The information can contain, for example, billing activities attributable to the financial transaction processing entity (e.g., a payment card company) and purchasing and payment activities, including date and time, attributable to payment card holders, merchant information, demographic (e.g., age and gender), geographic (e.g., zip code and state or country of residence), and the like. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive merchant expansion model is retrieved from each of the databases.

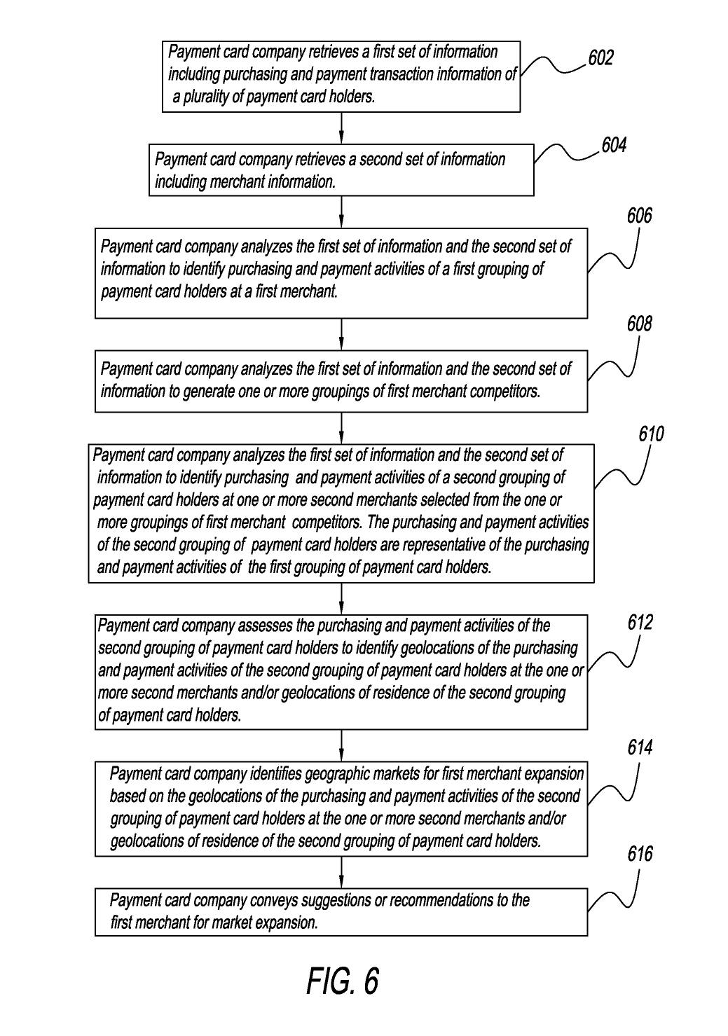

FIG. 6 illustrates an exemplary method for an entity (e.g., payment card company) conveying suggestions or recommendations to another entity (e.g., merchant) in accordance with the method of this disclosure. At step 602, a payment card company (part of the payment card company network 150 in FIG. 1) retrieves, from one or more databases, a first set of information including purchasing and payment information attributable to a plurality of payment card holders. The information at 602 includes payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders. The payment card company retrieves, from one or more databases, a second set of information including merchant information at 604. The merchant information at 604 includes categories of merchants, merchant name, merchant geography, merchant line of business, and the like. The merchant information 604 also includes, for example, a merchant identifier, geolocation of merchant, and the like. The payment card company optionally retrieves, from one or more databases, other information including demographic, firmographic and/or geographic information (not shown in FIG. 6).

In step 606, the payment card company analyzes the information from 602 and 604, including purchasing and payment information attributable to a plurality of payment card holders and merchant information, to identify purchasing and payment activities of a first grouping of payment card holders at a first merchant.

In step 608, the payment card company analyzes the information from 602 and 604, including purchasing and payment information attributable to a plurality of payment card holders and merchant information, to generate one or more groupings of first merchant competitors.

In step 610, the payment card company analyzes the information from 602 and 604, including purchasing and payment information attributable to a plurality of payment card holders and merchant information, to identify purchasing and payment activities of a second grouping of payment card holders at one or more second merchants selected from the one or more groupings of first merchant competitors. The purchasing and payment activities of the second grouping of payment card holders are representative of the purchasing and payment activities of the first grouping of payment card holders.

In step 612, the payment card company assesses assessing the purchasing and payment activities of the second grouping of payment card holders to identify geolocations of the purchasing and payment activities of the second grouping of payment card holders at the one or more second merchants and/or geolocations of residence of the second grouping of payment card holders.

In step 614, the payment card company identifies geographic markets for first merchant expansion based on the geolocations of the purchasing and payment activities of the second grouping of payment card holders at the one or more second merchants and/or geolocations of residence of the second grouping of payment card holders.

The payment card company conveys suggestions or recommendations to the first merchant at 616 to use for merchant expansion decision making. In an embodiment, the payment card company conveys to the merchant at 616 a geographic market location score based on the assessment. The score is indicative of the strength of a geographic market location as compared to the strength of another geographic market location that is under consideration for potential market expansion locations by a merchant.

In an embodiment, the merchant provides feedback to the payment card company to enable the payment card company to monitor and track impact of the recommendations and suggestions. This “closed loop” system allows the payment card company to make any improvements to the method and system of this disclosure.

One or more algorithms can be employed to determine formulaic descriptions of the assembly of the payment card holder information including purchasing and payment transactions, merchant information, and optionally demographic, firmographic and/or geographic information, using any of a variety of known mathematical techniques. These formulas, in turn, can be used to derive or generate assessments and/or indices using any of a variety of available trend analysis algorithms.

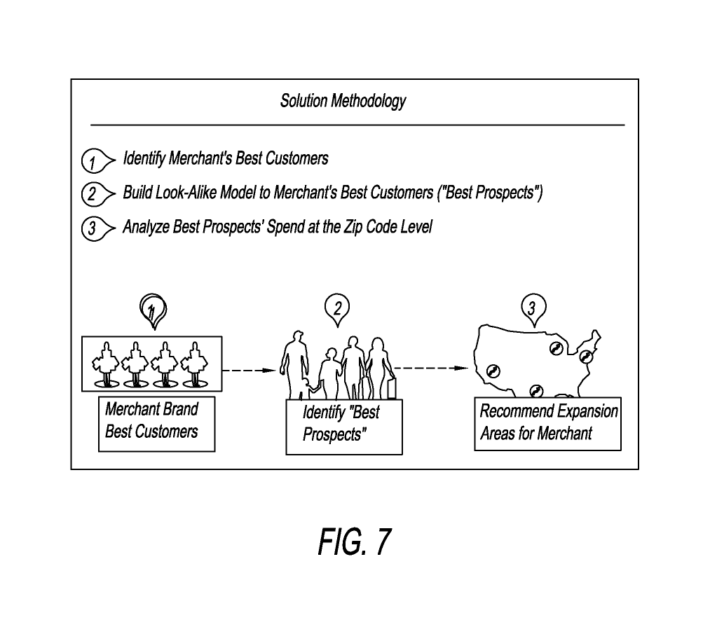

FIG. 7 illustrates an exemplary solution methodology for identifying geographic markets for merchant expansion in accordance with exemplary embodiments of this disclosure. As shown in FIG. 7, the methodology includes (1) identifying a merchant's best customers, (2) building a look-alike model to the merchant's best customers (best prospect customers), and (3) analyze the best prospect customers' spend at the zip code level to identify preferred geolocations for merchant expansion. Recommendations can be made to a merchant based on the preferred geolocations for merchant expansion.

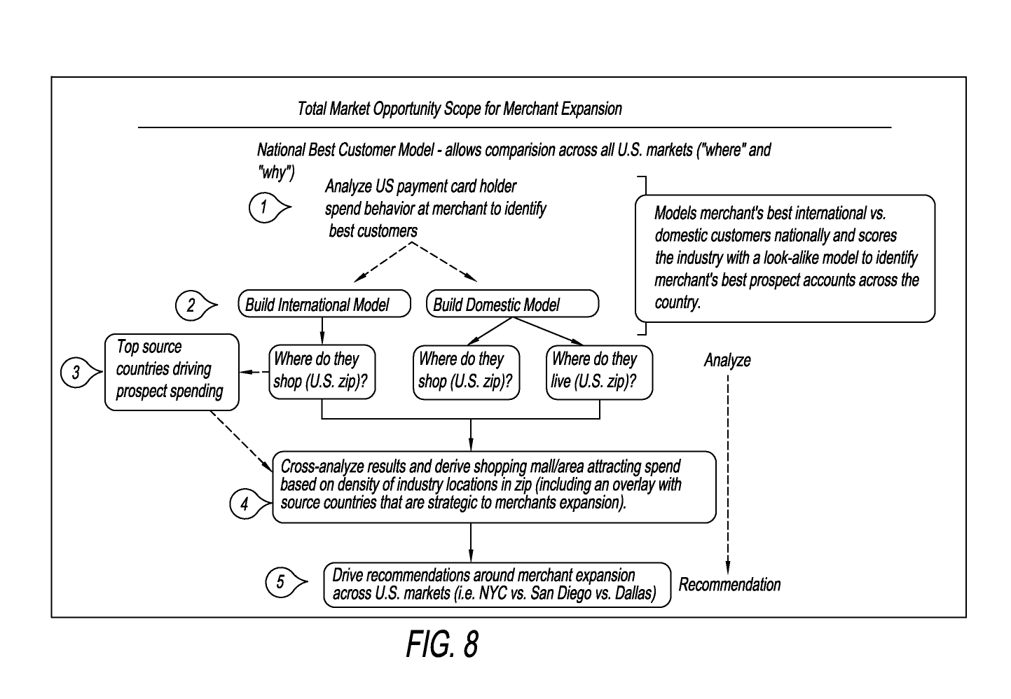

FIG. 8 illustrates an exemplary total market opportunity scope for merchant expansion in accordance with exemplary embodiments of this disclosure. The spend behavior of a plurality of payment card holders at a merchant is analyzed to identify the best customers of the merchant. Both an international model and a domestic model are built for assessing merchant expansion. The merchant's best international versus domestic customers are modeled nationally and across industry with a look-alike model to identify the merchant's best prospect accounts across the country. For the domestic model, it is determined where payment card holders shop (e.g., U.S. zip code) and where payment card holders live. For the international model, it is determined where the payment card holders shop (e.g., U.S. zip code). In the international model, top source countries driving the prospect customer spending are identified. The results are cross-analyzed to derive shopping mall/areas attracting spend based on the density of industry locations in zip code. This can include an overlay with source countries that are strategic to a merchant's expansion. Recommendations can be driven around merchant expansion across U.S., markets (e.g., New York City vs. San Diego Versus Dallas).

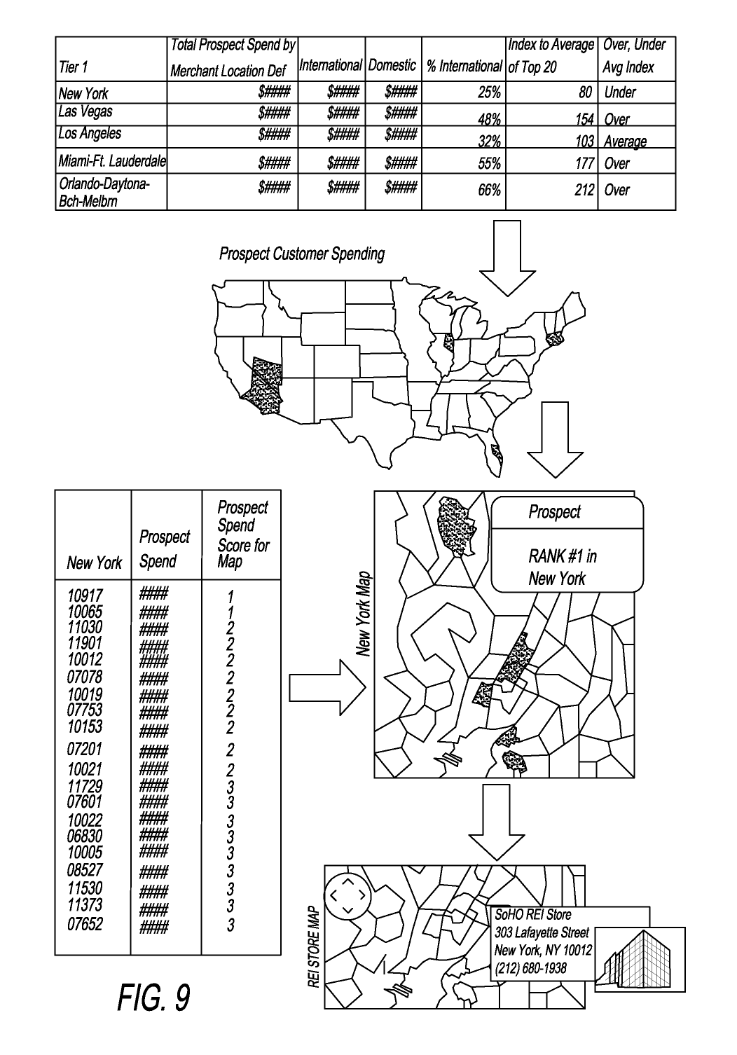

FIG. 9 illustrates an exemplary data set for identifying geographic markets for merchant expansion in accordance with exemplary embodiments of this disclosure. Designated market area (DMA) level recommendations based on top markets for domestic and international spend and make up of those markets (% international spend, % domestic spend, over/under index to international spend, and the like) are shown in FIG. 9. From the top prospect spend data by merchant location, the markets can be mapped based on demand as shown in the map of the continental United States. Zip code level recommendations can be made within the top markets. As shown for the zip codes for New York, the scores will drive heat mapping (illustrative for effect) of the recommended areas and the merchant will see the concentration of where the spending is occurring of the best prospect customers (i.e., look-alikes to the merchant's best customers). An overlay of where the merchant stores are currently located can be made on the map so that location gaps can be seen (see the example for a sporting goods merchant in the FIG. 9).

In accordance with this disclosure, indexing can be used to measure the degree to which total domestic payment card holder purchasing and payment activity at the one or more second merchants, and total foreign payment card holder purchasing and payment activity at the one or more second merchants, are correlated for a defined time period. Indexing can be used to determine where domestic and foreign payment card holders are coming from; whether domestic and foreign payment card holders are spending more or less in a particular area/place/industry in comparison to a competing area/place/industry and if so, how much; what domestic and foreign payment card holders are spending on including which industries and merchants; when domestic and foreign payment card holders are buying and what times they are buying; whether there is seasonality involved with the domestic and foreign payment card holders in a particular geographical area; and the like. The indexing is based on domestic and foreign payment card holder transaction information, merchant categorization information and other information indicative of spend patterns of domestic and foreign payment card holders.

An indexing score can be used for assessing purchasing and payment behavior of the plurality of domestic and foreign payment card holders at a specific location (e.g., as shown in FIG. 9, an over/under index based on international spend for the DMA level recommendations based on top markets for domestic and international spend). The indexing score can be trended over time. Proper merchant categorization is important for obtaining indexing results that are truly reflective of the particular merchant and industry, in particular, for determining how domestic and foreign purchasing and payment behavior is trending at a specific location in comparison to another location in the same industry category.

The indexing can be updated or refreshed at a specified time (e.g., on a regular basis or upon request of a party). Updating the indexing can include updating the domestic and foreign payment card transaction data, merchant data, and optionally demographic data and/or updated geographic data. Indexing can also be updated by changing the attributes that define each merchant, and generating a different merchant categorization. The process for updating indexing can depend on the circumstances regarding the need for the information itself.

One or more algorithms can be employed to determine formulaic descriptions of the assembly of the domestic and foreign payment card transaction information, merchant categorization information, and optionally demographic and/or geographic information, using any of a variety of known mathematical techniques. These formulas, in turn, can be used to derive or generate indexing using any of a variety of available analysis algorithms.

In accordance with this disclosure, one or more predictive merchant expansion models are generated based at least in part on the first set of information and the second set of information. Predictive merchant expansion models can be selected based on the information obtained and stored in the one or more databases. The selection of information for representation in the predictive merchant expansion models can be different in every instance. In one embodiment, all information stored in each database can be used for selecting predictive merchant expansion models. In an alternative embodiment, only a portion of the information is used. The generation and selection of predictive merchant expansion models can be based on specific criteria.

Predictive merchant expansion models are generated from the information obtained from each database. The information is analyzed, extracted and correlated by, for example, a financial transaction processing company (e.g., a payment card company), and can include domestic and foreign financial account information, merchant information, performing statistical analysis on domestic and foreign financial account information and merchant information, finding correlations between account information, merchant information and domestic and foreign payment card holder behaviors, predicting future domestic and foreign payment card holder behaviors based on domestic and foreign account information and merchant information, and the like.

Predictive merchant expansion models can be defined based on geographical and optionally demographical information, including but not limited to, age, gender, income, marital status, postal code, income, spending propensity, and familial status. In some embodiments, predictive merchant expansion models can be defined by a plurality of geographical and/or demographical categories. For example, a predictive merchant expansion model can be defined for any merchant having customers who are payment card holders and who engage in purchasing and spending activity at competitive merchants.

Predictive merchant expansion models can also be based on behavioral variables. For example, the financial transaction processing entity database can store information relating to financial transactions. The information can be used to determine an individual's likeliness to spend at a particular geolocation and at particular date and time. An individual's likeliness to spend can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information.

Behavioral variables can also be applied to generated predictive merchant expansion models based on the attributes of the entities. For example, a predictive merchant expansion model of specific geographical and demographical attributes can be analyzed for spending behaviors at specific merchant locations. Results of the analysis can be assigned to the predictive merchant expansion models.

In an embodiment, the information retrieved from each of the databases can be analyzed to determine behavioral information of the domestic and foreign payment card holders. Also, information related to an intention of the domestic and foreign payment card holders can be extracted from the behavioral information. The predictive merchant expansion models can be based upon the behavioral information of the domestic and foreign payment card holders and the intent of the domestic and foreign payment card holders. The predictive merchant expansion models can be capable of predicting one or more geolocations for merchant expansion.

Predictive merchant expansion models can be updated or refreshed at a specified time (e.g., on a regular basis or upon request of a party). Updating predictive merchant expansion models can include updating the entities included in each predictive merchant expansion model with updated demographic data and/or updated financial data. Predictive merchant expansion models can also be updated by changing the attributes that define each predictive merchant expansion model, and generating a different set of behaviors. The process for updating predictive merchant expansion models can depend on the circumstances regarding the need for the information itself.

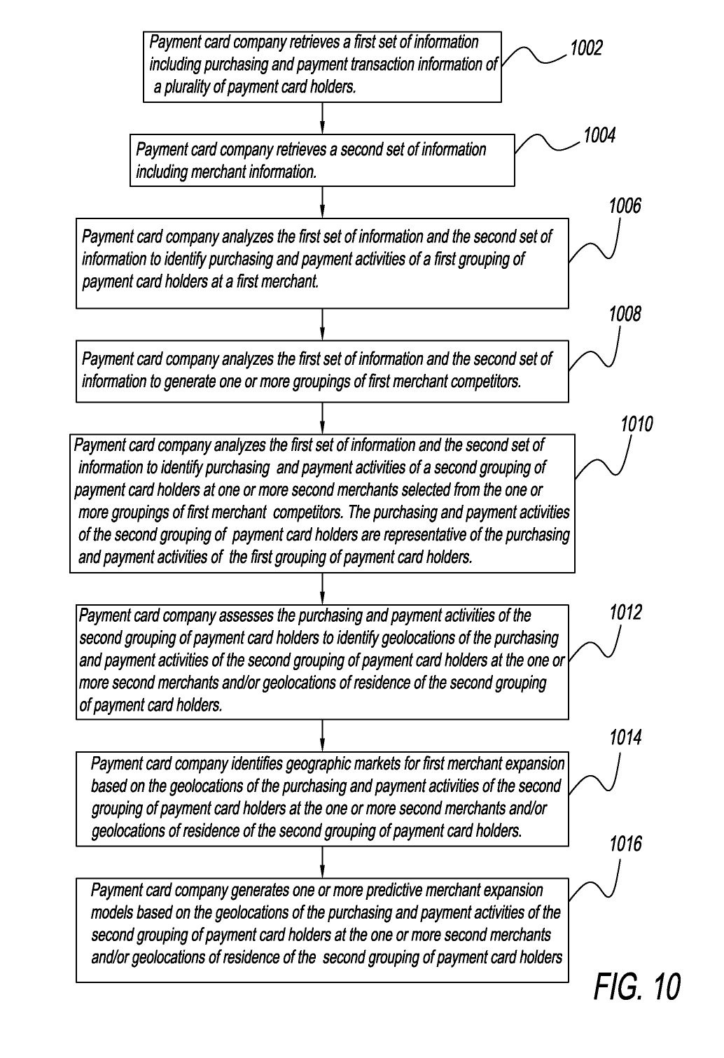

A method for generating one or more predictive merchant expansion models is an embodiment of this disclosure. Referring to FIG. 10, the method involves a payment card company (part of the payment card company network 150 in FIG. 1) retrieving, from one or more databases, a first set of information including purchasing and payment information attributable to a plurality of payment card holders at 1002. The information at 1002 includes payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders. The payment card company retrieves, from one or more databases, a second set of information including merchant information at 1004. The merchant information at 1004 includes categories of merchants, merchant name, merchant geography, merchant line of business, and the like. The merchant information 1004 also includes, for example, a merchant identifier, geolocation of merchant, and the like. The payment card company optionally retrieves, from one or more databases, other information including demographic, firmographic and/or geographic information (not shown in FIG. 10).

In step 1006, the payment card company analyzes the information from 1002 and 1004, including purchasing and payment information attributable to a plurality of payment card holders and merchant information, to identify purchasing and payment activities of a first grouping of payment card holders at a first merchant.

In step 1008, the payment card company analyzes the information from 1002 and 1004, including purchasing and payment information attributable to a plurality of payment card holders and merchant information, to generate one or more groupings of first merchant competitors.

In step 1010, the payment card company analyzes the information from 1002 and 1004, including purchasing and payment information attributable to a plurality of payment card holders and merchant information, to identify purchasing and payment activities of a second grouping of payment card holders at one or more second merchants selected from the one or more groupings of first merchant competitors. The purchasing and payment activities of the second grouping of payment card holders are representative of the purchasing and payment activities of the first grouping of payment card holders.

In step 1012, the payment card company assesses the purchasing and payment activities of the second grouping of payment card holders to identify geolocations of the purchasing and payment activities of the second grouping of payment card holders at the one or more second merchants and/or geolocations of residence of the second grouping of payment card holders.

In step 1014, the payment card company identifies geographic markets for first merchant expansion based on the geolocations of the purchasing and payment activities of the second grouping of payment card holders at the one or more second merchants and/or geolocations of residence of the second grouping of payment card holders.

In step 1016, the payment card company generates one or more predictive merchant expansion models based on the geolocations of the purchasing and payment activities of the second grouping of payment card holders at the one or more second merchants and/or geolocations of residence of the second grouping of payment card holders.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications can be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
analyzing purchasing and payment activities of a first grouping of payment card holders at a first merchant;
analyzing purchasing and payment activities of a second grouping of payment card holders at one or more second merchants, wherein the one or more second merchants are selected from one or more first merchant competitors, and wherein the purchasing and payment activities of the second grouping of payment card holders are representative of the purchasing and payment activities of the first grouping of payment card holders;
identifying geolocations of the purchasing and payment activities of the second grouping of payment card holders at the one or more second merchants and/or geolocations of residence of the second grouping of payment card holders; and
identifying geographic markets for first merchant expansion based on the geolocations of the purchasing and payment activities of the second grouping of payment card holders at the one or more second merchants and/or geolocations of residence of the second grouping of payment card holders.

2. A method comprising:
retrieving from one or more databases a first set of information including purchasing and payment activity information attributable to a plurality of payment card holders;
retrieving from one or more databases a second set of information including merchant information associated with the purchasing and payment activity;
analyzing the first set of information and the second set of information to identify purchasing and payment activities of a first grouping of payment card holders at a first merchant;
analyzing the first set of information and the second set of information to generate one or more groupings of first merchant competitors;
analyzing the first set of information and the second set of information to identify purchasing and payment activities of a second grouping of payment card holders at one or more second merchants selected from the one or more groupings of first merchant competitors, wherein the purchasing and payment activities of the second grouping of payment card holders are representative of the purchasing and payment activities of the first grouping of payment card holders;
assessing the purchasing and payment activities of the second grouping of payment card holders to identify geolocations of the purchasing and payment activities of the second grouping of payment card holders at the one or more second merchants and/or geolocations of residence of the second grouping of payment card holders; and
identifying geographic markets for first merchant expansion based on the geolocations of the purchasing and payment activities of the second grouping of payment card holders at the one or more second merchants and/or geolocations of residence of the second grouping of payment card holders.

3. The method of claim 1, wherein the geolocations of the purchasing and payment activities of the second grouping of payment card holders at the one or more second merchants and/or geolocations of residence of the second grouping of payment card holders are clustered or aggregated by countries, states, zip codes, metropolitan areas (metropolitan statistical area (MSA), or designated market areas (DMA).

4. The method of claim 1, wherein the purchasing and payment activities of the second grouping of payment card holders includes domestic payment card holder purchasing and payment activity and foreign payment card holder purchasing and payment activity.

5. The method of claim 4, further comprising:
identifying geographic markets for first merchant expansion based on the geolocations of the purchasing and payment activities of the second grouping of domestic and/or foreign payment card holders at the one or more second merchants and/or geolocations of residence of the second grouping of domestic and/or foreign payment card holders.

6. The method of claim 5, further comprising:
generating one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders.

7. The method of claim 6, wherein the one or more indices are a measure of the degree to which total domestic payment card holder purchasing and payment activity at the one or more second merchants, and total foreign payment card holder purchasing and payment activity at the one or more second merchants, are correlated for a defined time period.

8. The method of claim 6, further comprising algorithmically generating the one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders.

9. The method of claim 1, further comprising:
retrieving from the one or more databases a third set of information comprising other information, wherein the other information comprises at least one of geographic data, firmographic data, or demographic data.

10. The method of claim 1, further comprising creating one or more datasets to store information relating to the purchasing and payment activity attributable to a plurality of payment card holders, merchant information associated with the purchasing and payment activity; purchasing and payment activities of a first grouping of payment card holders at a first merchant, one or more groupings of first merchant competitors, purchasing and payment activities of a second grouping of payment card holders at one or more second merchants selected from the one or more groupings of first merchant competitors, geolocations of the purchasing and payment activities of the second grouping of payment card holders at the one or more second merchants and/or geolocations of residence of the second grouping of payment card holders, and one or more predictive merchant expansion models.

11. The method of claim 1, wherein analyzing the first set of information and the second set of information to identify purchasing and payment activities of a second grouping of payment card holders at one or more second merchants selected from the one or more groupings of first merchant competitors, is conducted by statistical analysis selected from the group consisting of clustering, regression, correlation, segmentation, and raking.

12. The method of claim 1, further comprising:
generating one or more predictive merchant expansion models based on the geolocations of the purchasing and payment activities of the second grouping of payment card holders at the one or more second merchants and/or geolocations of residence of the second grouping of payment card holders.

13. The method of claim 12, further comprising algorithmically identifying geographic markets for first merchant expansion based on the one or more predictive merchant expansion models.

14. The method of claim 12, further comprising conveying information including at least one or more targeted suggestions or recommendations to the first merchant for market expansion, based on the one or more predictive merchant expansion models.

15. A system comprising:
one or more databases configured to store information including purchasing and payment activity information attributable to a plurality of payment card holders;
one or more databases configured to store information including merchant information associated with the purchasing and payment activity;
a processor configured to:
analyze purchasing and payment activities of a first grouping of payment card holders at a first merchant;
analyze purchasing and payment activities of a second grouping of payment card holders at one or more second merchants, wherein the one or more second merchants are selected from one or more first merchant competitors, and wherein the purchasing and payment activities of the second grouping of payment card holders are representative of the purchasing and payment activities of the first grouping of payment card holders;
identify geolocations of the purchasing and payment activities of the second grouping of payment card holders at the one or more second merchants and/or geolocations of residence of the second grouping of payment card holders; and
identify geographic markets for first merchant expansion based on the geolocations of the purchasing and payment activities of the second grouping of payment card holders at the one or more second merchants and/or geolocations of residence of the second grouping of payment card holders.

16. A system comprising:
one or more databases configured to store a first set of information including purchasing and payment activity information attributable to a plurality of payment card holders;
one or more databases configured to store a second set of information including merchant information associated with the purchasing and payment activity;
a processor configured to:
analyze the first set of information and the second set of information to identify purchasing and payment activities of a first grouping of payment card holders at a first merchant;
analyze the first set of information and the second set of information to generate one or more groupings of first merchant competitors;
analyze the first set of information and the second set of information to identify purchasing and payment activities of a second grouping of payment card holders at one or more second merchants selected from the one or more groupings of first merchant competitors, wherein the purchasing and payment activities of the second grouping of payment card holders are representative of the purchasing and payment activities of the first grouping of payment card holders;
assess the purchasing and payment activities of the second grouping of payment card holders to identify geolocations of the purchasing and payment activities of the second grouping of payment card holders at the one or more second merchants and/or geolocations of residence of the second grouping of payment card holders; and
identify geographic markets for first merchant expansion based on the geolocations of the purchasing and payment activities of the second grouping of payment card holders at the one or more second merchants and/or geolocations of residence of the second grouping of payment card holders.

17. The system of claim 16, wherein the geolocations of the purchasing and payment activities of the second grouping of payment card holders at the one or more second merchants and/or geolocations of residence of the second grouping of payment card holders are clustered or aggregated by countries, states, zip codes, metropolitan areas (metropolitan statistical area (MSA), or designated market areas (DMA).

18. The system of claim 16, wherein the processor is configured to generate one or more indices based on the purchasing and payment activities and the geolocations of the purchasing and payment activities of the second grouping of payment card holders at the one or more second merchants and/or geolocations of residence of the second grouping of payment card holders.

19. The system of claim 18, wherein the processor is configured to algorithmically generate the one or more indices based on the purchasing and payment activities and the geolocations of the purchasing and payment activities of the second grouping of domestic and/or foreign payment card holders at the one or more second merchants and/or geolocations of residence of the second grouping of domestic and/or foreign payment card holders.

20. The system of claim 16, further comprising:
one or more databases configured to store a third set of information comprising other information, wherein the other information comprises geographic data, firmographic data, and demographic data.

21. The system of claim 16, wherein the processor is also configured to include one or more functions selected from the group consisting of (a) create one or more datasets to store information relating to the purchasing and payment activity attributable to a plurality of payment card holders; merchant information associated with the purchasing and payment activity; purchasing and payment activities of a first grouping of payment card holders at a first merchant; one or more groupings of first merchant competitors;
purchasing and payment activities of a second grouping of payment card holders at one or more second merchants selected from the one or more groupings of first merchant competitors; geolocations of the purchasing and payment activities of the second grouping of payment card holders at the one or more second merchants and/or geolocations of residence of the second grouping of payment card holders; and one or more predictive merchant expansion models; (b) analyze the first set of information and the second set of information to identify purchasing and payment activities of a second grouping of payment card holders at one or more second merchants selected from the one or more groupings of first merchant competitors by statistical analysis selected from the group consisting of clustering, regression, correlation, segmentation, and raking; (c) generate one or more predictive merchant expansion models based on the geolocations of the purchasing and payment activities of the second grouping of payment card holders at the one or more second merchants and/or geolocations of residence of the second grouping of payment card holders; (d) algorithmically identify geographic markets for first merchant expansion based on the one or more predictive merchant expansion models, and (e) target information including at least one or more suggestions or recommendations to the first merchant for market expansion, based on the one or more predictive merchant expansion models.

22. A method for generating one or more predictive merchant expansion models, the method comprising:
analyzing purchasing and payment activities of a first grouping of payment card holders at a first merchant;
analyzing purchasing and payment activities of a second grouping of payment card holders at one or more second merchants, wherein the one or more second merchants are selected from one or more first merchant competitors, and wherein the purchasing and payment activities of the second grouping of payment card holders are representative of the purchasing and payment activities of the first grouping of payment card holders;
identifying geolocations of the purchasing and payment activities of the second grouping of payment card holders at the one or more second merchants and/or geolocations of residence of the second grouping of payment card holders;
identifying geographic markets for first merchant expansion based on the geolocations of the purchasing and payment activities of the second grouping of payment card holders at the one or more second merchants and/or geolocations of residence of the second grouping of payment card holders; and
generating one or more predictive merchant expansion models based on the geolocations of the purchasing and payment activities of the second grouping of payment card holders at the one or more second merchants and/or geolocations of residence of the second grouping of payment card holders.

23. A method for generating one or more predictive merchant expansion models, the method comprising:
retrieving from one or more databases a first set of information including purchasing and payment activity information attributable to a plurality of payment card holders;
retrieving from one or more databases a second set of information including merchant information associated with the purchasing and payment activity;
analyzing the first set of information and the second set of information to identify purchasing and payment activities of a first grouping of payment card holders at a first merchant;
analyzing the first set of information and the second set of information to generate one or more groupings of first merchant competitors;
analyzing the first set of information and the second set of information to identify purchasing and payment activities of a second grouping of payment card holders at one or more second merchants selected from the one or more groupings of first merchant competitors; wherein the purchasing and payment activities of the second grouping of payment card holders are representative of the purchasing and payment activities of the first grouping of payment card holders;
assessing the purchasing and payment activities of the second grouping of payment card holders to identify geolocations of the purchasing and payment activities of the second grouping of payment card holders at the one or more second merchants and/or geolocations of residence of the second grouping of payment card holders;
identifying geographic markets for first merchant expansion based on the geolocations of the purchasing and payment activities of the second grouping of payment card holders at the one or more second merchants and/or geolocations of residence of the second grouping of payment card holders; and
generating one or more predictive merchant expansion models based on the geolocations of the purchasing and payment activities of the second grouping of payment card holders at the one or more second merchants and/or geolocations of residence of the second grouping of payment card holders.

24. The method of claim 23, wherein the geolocations of the purchasing and payment activities of the second grouping of payment card holders at the one or more second merchants and/or geolocations of residence of the second grouping of payment card holders are clustered or aggregated by countries, states, zip codes, metropolitan areas (metropolitan statistical area (MSA), or designated market areas (DMA).

25. The method of claim 23, further comprising:
identifying geographic markets for first merchant expansion based on the geolocations of the purchasing and payment activities of the second grouping of payment card holders at the one or more second merchants and/or geolocations of residence of the second grouping of payment card holders.
